(19) United States
(12) Patent Application Publication
(10) Pub. No.: US 2013/0162934 A1
(43) Pub. Date: Jun. 27, 2013

(54) LIQUID CRYSTAL DISPLAY DEVICE, AND COLOR REPRODUCTION METHOD THEREOF

(71) Applicants: Yoshinobu Hirayama, Osaka (JP); Toshihiro Yanagi, Osaka (JP); Shigenori Tanaka, Osaka (JP); Ryoh Araki, Osaka (JP); Kei Oyobe, Osaka (JP)

(72) Inventors: Yoshinobu Hirayama, Osaka (JP); Toshihiro Yanagi, Osaka (JP); Shigenori Tanaka, Osaka (JP); Ryoh Araki, Osaka (JP); Kei Oyobe, Osaka (JP)

(73) Assignee: SHARP KABUSHIKI KAISHA, Osaka (JP)

(21) Appl. No.: 13/819,919

(22) PCT Filed: Aug. 29, 2011
(86) PCT No.: PCT/JP2011/069416

§ 371 Date: Feb. 28, 2013

(30) Foreign Application Priority Data
Sep. 3, 2010 (JP) 2010-197954

(51) Int. Cl. G02F 1/1335

(52) U.S. Cl. CPC G02F 1/133514
USPC 349/69

(57) ABSTRACT

This liquid crystal display device 1 has a backlight 4 and a liquid crystal panel 5 disposed on the light-emitting surface side of the backlight 4. The liquid crystal display device 1 further has a drive unit (not shown) for driving the liquid crystal panel 5. The backlight 4 is provided with at least one blue LED 2a for emitting blue light, and at least one white LED 2b for emitting white light. For each pixel, the liquid crystal panel 5 is provided with at least one red filter 10R that transmits light in the red wavelength region, at least one green filter 10G that transmits light in the green wavelength region, and at least one white filter 10W that transmits light in all wavelength regions.

### TECHNICAL FIELD

The present invention relates to a liquid crystal display device and a color reproduction method thereof.

### BACKGROUND ART

There are various types of color displays, each of which is in practical use. Flat-screen displays include light-emitting displays such as plasma display panels (PDP), and non-light-emitting displays such as liquid crystal display (LCD) devices. Among liquid crystal display devices, which are non-light-emitting displays, a transmissive liquid crystal display device in which a backlight is disposed on the rear side of the liquid crystal panel is known.

In such a transmissive liquid crystal display device, a backlight is disposed on the rear side of the liquid crystal panel. The liquid crystal panel can display color by being provided with color filters in the liquid crystal panel. In addition, by controlling a voltage applied to the liquid crystal layer, the amount of light transmitted through the liquid crystal panel can be controlled for each pixel. In other words, a transmissive liquid crystal display device conducts display control by controlling the amount of illumination light from the backlight transmitted through the liquid crystal panel.

The backlight radiates light that includes wavelengths for the three colors RGB, which are necessary for color display, and in combination with color filters, the transmittance of light of each color RGB is adjusted, thus allowing a desired brightness and hue to be set for each pixel. White light sources such as electroluminescent (EL) lamps, cold cathode fluorescent lamps (CCFL), and light-emitting diodes (LED) are generally used for the backlight, but a configuration in which a light source is provided for each color RGB is also used.

In recent years, the light-emitting efficiency and the like of light-emitting diodes (LED) have improved and the cost thereof has decreased, which means that LEDs are beginning to be used for the backlight of liquid crystal display devices. Types of backlights that use LEDs include a direct lighting device in which LEDs are disposed directly under the rear side of the liquid crystal panel and an edge light type that uses a light guide plate. In general, the former has a higher light usage efficiency than the latter, and can be made lighter in weight.

LED backlights include a type in which LEDs of the three colors red (R), green (G), and blue (B) are arranged in rows and light of a desired color is emitted by adjusting the wavelength and intensity of the light of the three colors, and a type in which light of a desired color is emitted by combining white LEDs with color filters and by adjusting the light transmittance of each RGB color filter.

In general, various characteristics such as temperature characteristics differ among the three LED colors, and thus, it is easier to control the latter than the former, and a driving method of the latter is simpler than that of the former. FIG. 9 shows a conventional liquid crystal display device that uses a white LED and color filters. FIG. 9 is a drawing that schematically shows a conventional liquid crystal display device 11.

In a liquid crystal panel 15 of the liquid crystal display device 11, a plurality of pixels are arranged in a matrix, and each pixel is typically constituted of three sub-pixels. As shown in FIG. 9, each sub-pixel is disposed so as to correspond to a red (R) color filter (red filter 10R), a green (G) color filter (green filter 10G), and a blue (B) color filter (blue filter 10B).

Each RGB sub-pixel selectively transmits specific wavelength regions (in other words, red, green, or blue) among the white light emitted from a white LED 12 of a backlight 14, and absorbs the other wavelength regions of light. Specifically, color filters (10R, 10G, and 10B) that have transmittance distributions as shown in FIG. 10 are used. In the case of the red filter 10R, the wavelength with a maximum spectral transmittance is 600 nm or greater (heavy line in the drawing); in the case of the green filter 10G, the wavelength with a maximum spectral transmittance is between 500 nm and 570 nm inclusive (solid line in the drawing); and in the case of the blue filter 10B, the wavelength with a maximum spectral transmittance is between 420 nm and 500 nm inclusive (broken line in the drawing). By relying on the transmittance characteristics of each of the color filters, the light transmittance of each color RGB can be adjusted, respectively.

Patent Document 1 discloses a technique for increasing the color reproducibility in a backlight that uses a white LED and color filters. FIG. 11 shows a liquid crystal display device disclosed in Patent Document 1.

Patent Document 1 discloses a configuration as shown in FIG. 11 in which white light radiated into the color filters is generated by mixing light emitted from a blue LED 22a with light emitted from a white LED 22b within a light guide plate 23. According to this configuration, it is possible to adjust the white light, which results in a backlight 24 with a high color reproducibility.

### RELATED ART DOCUMENTS

### Patent Documents

Patent Document 1: Japanese Patent Application Laid-Open Publication, “Japanese Patent Application Laid-Open Publication No. 2009-245902 (Published on Oct. 22, 2009)”

### SUMMARY OF THE INVENTION

### Problems to be Solved by the Invention

Of the light emitted by the backlight in the above-mentioned liquid crystal display device, the amount of light transmitted through each pixel of the liquid crystal panel is controlled, which naturally means that some light is absorbed by the liquid crystal panel. Also, at the color filters, the RGB sub-pixels absorb light other than the corresponding wavelength region among the white light generated by the backlight. In this way, general liquid crystal display devices have a high rate of absorbance of light by the liquid crystal panel and the color filters, which reduces the usage efficiency of illumination light from the backlight, which increases the amount of electrical power used by the backlight.

However, with the conventional configuration, while it is possible to reduce the amount of electrical power used by the backlight by reducing the amount of light absorbed by the liquid crystal panel, it is not possible to reduce the amount of light absorbed by the color filters. Thus, even with the technique disclosed in Patent Document 1, while the color reproducibility can be increased, the amount of light absorbed by the color filters cannot be reduced. As a result, the usage efficiency of illumination light from the backlight is low, and an increase in brightness of the liquid crystal display device cannot be achieved.

Because of the reasons above, if the usage efficiency of the illumination light from the backlight can be increased, it is possible to further increase the brightness of the liquid crystal display device and further reduce the electrical power usage. The present invention is made in view of such problems, and an object thereof is to provide a liquid crystal display device and a color reproduction method thereof that can increase the usage efficiency of illumination light from the backlight, further increase the brightness of the liquid crystal display device, and further decrease the electrical power usage.

### Means for Solving the Problems

In order to solve the above-mentioned problems, a liquid crystal display device according to one aspect of the present invention includes: a light source that emits light towards an exterior; and a liquid crystal panel to which the light from the light source is radiated, wherein the light source is provided with at least one blue light-emitting diode that emits blue light, and at least one white light-emitting diode that emits white light, and wherein, for each pixel, the liquid crystal panel is provided with at least one red filter that transmits light of a red wavelength region, at least one green filter that transmits light of a green wavelength region, and at least one white filter that transmits light of all wavelength regions.

According to the above configuration, a white filter is used instead of a blue filter, and thus, light emitted by the blue light-emitting diode and the white light-emitting diode is transmitted through the white filter as is. Thus, not much light is lost through absorption at the white filter, which means that the amount of light emitted by the liquid crystal display device is large. Therefore, the liquid crystal display device according to one aspect of the present invention has a high usage efficiency of light from a light source compared to a conventional liquid crystal display device, and the brightness of the liquid crystal display device can thus be increased. Also, according to one aspect of the present invention, it is possible to decrease the amount of light absorbed by the color filters, which reduces the amount of electrical power used by the liquid crystal display device.

Also, a liquid crystal display device according to one aspect of the present invention can display white using the blue light-emitting diode and the white light-emitting diode. As a result, the brightness of the liquid crystal display device can be increased.

In order to solve the above-mentioned problems, in a color reproduction method of the above-mentioned liquid crystal display device according to one aspect of the present invention, when producing red, the white light-emitting diode is lit and light from the white light-emitting diode is transmitted through the red filter, when producing green, the white light-emitting diode is lit and light from the white light-emitting diode is transmitted through the green filter, when producing blue, the blue light-emitting diode is lit and light from the blue light-emitting diode is transmitted through the white filter, and when producing white, the blue light-emitting diode and the white light-emitting diode are lit and light from the blue light-emitting diode and light from the white light-emitting diode are transmitted through the red filter, the green filter, and the white filter.

According to the above-mentioned method, it is possible to provide a color reproduction method that can achieve a high usage efficiency of light from the light source, an improvement in the brightness of the liquid crystal display device, and a reduction in the amount of electrical power used by the liquid crystal display device.

Other objects, characteristics, and advantages of the present invention can be sufficiently understood by the description below. Also, advantages of the present invention are made clearer by the following description, which refers to the attached drawings.

### Effects of the Invention

According to a liquid crystal display device of one aspect of the present invention, the usage efficiency of light from the light source is high and the brightness of the liquid crystal display device can be increased. Also, according to one aspect of the present invention, it is possible to decrease the amount of light absorbed by the color filters, which reduces the amount of electrical power used by the liquid crystal display device.

### BRIEF DESCRIPTION OF THE DRAWINGS

FIG. 1 is a drawing that schematically shows a liquid crystal display device according to one embodiment of the present invention.

FIG. 2 is a drawing that shows the spectral distribution of a white light-emitting diode in which the surface of a light-emitting diode that emits blue light is coated with a yellow fluorescent material.

FIG. 3 is a drawing that shows the spectral distribution of a white light-emitting diode in which the surface of a light-emitting diode that emits blue light is coated with a combination of a red fluorescent material and a green fluorescent material.

FIG. 4 is a schematic drawing that shows the transmittance of light when blue light is emitted in a liquid crystal display device according to one embodiment of the present invention.

FIG. 5 is a schematic drawing that shows the transmittance of light when green light is emitted in a liquid crystal display device according to one embodiment of the present invention.

FIG. 6 is a schematic drawing that shows the transmittance of light when red light is emitted in a liquid crystal display device according to one embodiment of the present invention.

FIG. 7 is a schematic drawing that shows the transmittance of light when white light is emitted in a liquid crystal display device according to one embodiment of the present invention.

FIG. 8 is a schematic drawing that shows the transmittance of light when only the white light-emitting diode according to one embodiment of the present invention is lit.

FIG. 9 is a drawing that schematically shows a conventional liquid crystal display device.

FIG. 10 is a drawing that shows a transmittance distribution of color filters of each color.

FIG. 11 is a drawing that schematically shows a conventional liquid crystal display device.

### DETAILED DESCRIPTION OF EMBODIMENTS

A liquid crystal display (LCD) device according to one embodiment of the present invention will be described below in detail with reference to the drawings.

(Summary of Liquid Crystal Display Device)

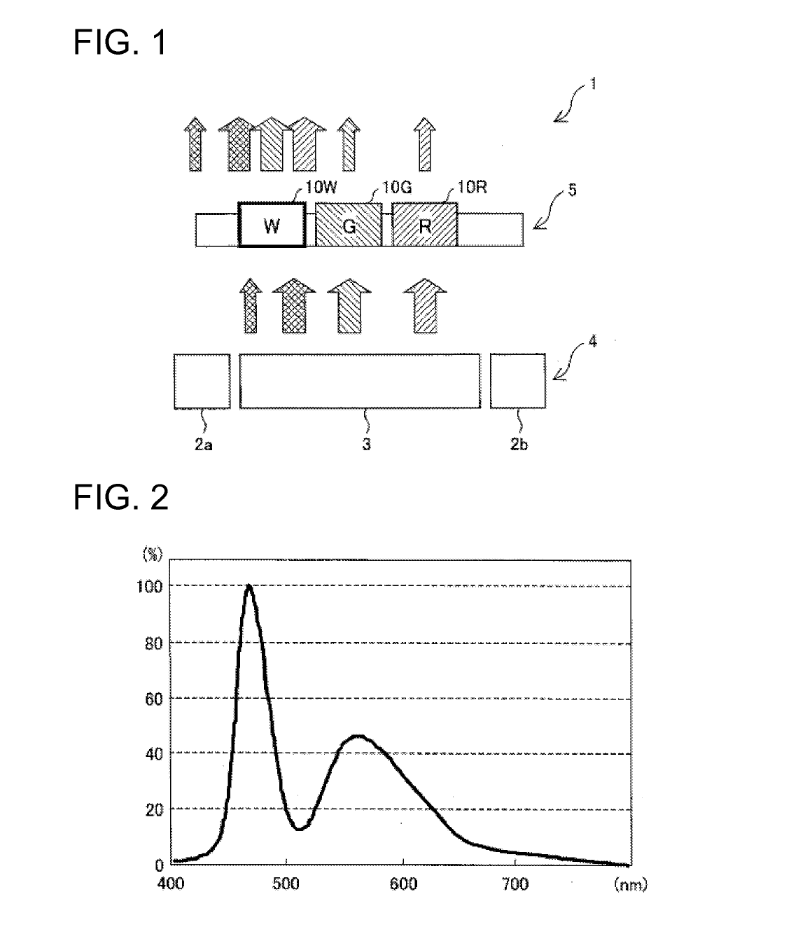

First, a liquid crystal display device according to the present embodiment will be summarized with reference to FIG. 1. FIG. 1 is a drawing that schematically shows a liquid crystal display device 1 according to the present embodiment.

As shown in FIG. 1, the liquid crystal display device 1 has a backlight 4 and a liquid crystal panel 5 disposed on the light-emitting side of the backlight 4. The liquid crystal display device 1 additionally has a drive unit (not shown in the drawing) that drives the liquid crystal panel 5. Also, in FIG. 1, some of the liquid crystal display device 1 is omitted from the drawing in order to show the schematic configuration of the liquid crystal display device 1.

The liquid crystal panel 5 has a liquid crystal layer (not shown in the drawing) in which liquid crystal cells are disposed in a regular manner, and color filters (10R, 10G, and 10W) disposed on the display side (side where light that enters the liquid crystal cells is discharged) of the liquid crystal layer. In the liquid crystal panel 5, the molecule orientation is changed by selectively applying an electric field to each liquid crystal cell of the liquid crystal layer, thus controlling the amount of light transmitted. Also, by selecting the light that is transmitted through the color filters, characters, figures, images, or the like are displayed on the surface of the liquid crystal panel 5.

The color filters of the liquid crystal panel 5 are described below. The color filters include a red filter 10R that transmits the red components of light, a green filter 10G that transmits the green components of light, and a white (non-colored) filter 10W that transmits all visible light, and the color filters are disposed in the liquid crystal panel 5.

The red filter 10R, the green filter 10G, and the white filter 10W, which constitute the color filters, are disposed in order according to set rules, as shown in FIG. 1. More specifically, for each pixel of the liquid crystal panel 5, at least one red filter 10R, at least one green filter 10G, and at least one white filter 10W are provided. Also, the above-mentioned liquid crystal cells are disposed so as to correspond to the respective filters.

Here, each color filter differs in transmittance characteristics, and has a high spectral transmittance in the wavelength region of the corresponding color and a low transmittance in other wavelength regions. Specifically, the red filter 10R is a film with transmittance characteristics in which the spectral transmittance is high for light of a wavelength of 600 nm or greater, which is the red component, and the spectral transmittance for light of other wavelength regions is low. The green filter 10G is a film with transmittance characteristics in which the spectral transmittance is high for light of a wavelength between 500 nm and 570 nm inclusive, which is the green component, and the spectral transmittance for light of other wavelength regions is low. The white filter 10W is a film that transmits all wavelength regions of visible light. In other words, in the case of the red filter 10R, the wavelength with the maximum spectral transmittance is 600 nm or greater, and in the case of the green filter 10G, the wavelength with the maximum spectral transmittance is between 500 nm and 570 nm inclusive. The light that is transmitted through the red filter 10R exits the filter as red light, the light that is transmitted through the green filter 10G exits the filter as green light, and the light that is transmitted through the white filter 10W exits the filter as is.

It is preferable that the red filter 10R, the green filter 10G, and the white filter 10W satisfy a size ratio of 1:1:1. This allows the liquid crystal display device 1 to be provided with a high brightness and a low electrical power usage. However, this size ratio of the color filters is only one example, and there is no limit on the size ratio.

The drive unit applies a voltage to transparent electrodes in the liquid crystal panel 5, thus changing the orientation direction of liquid crystal molecules in the liquid crystal cells and thereby controlling the transmittance of light transmitted through the liquid crystal panel 5. In other words, the drive unit controls the amount of light transmitted through each color filter in each position by controlling the orientation direction of the liquid crystal cells of the liquid crystal panel 5. In this manner, images and the like are displayed in the liquid crystal panel 5 by changing the amount of light that is transmitted through the color filters in each position.

The backlight 4 is an illumination device that emits light onto the entire surface of the liquid crystal panel 5 from the rear of the liquid crystal panel 5 and has a light-emitting surface that is substantially the same shape as the image display surface of the liquid crystal panel 5. The backlight 4 of the present embodiment has light sources (2a and 2b), and a light guide plate 3, as shown in FIG. 1. In the backlight 4, light from the light sources enters the light guide plate 3 and undergoes multiple reflection inside the light guide plate 3, and is emitted from the surface of the light guide plate 3 on the side of the liquid crystal panel 5. In this case, the backlight 4 has optical films (not shown in the drawing) that focus the light emitted by the light guide plate 3 and illuminate the liquid crystal panel 5, and a reflective film (not shown in the drawing) for returning light that has leaked from the light guide plate 3 into the side opposite to the liquid crystal panel 5 to the light guide plate 3.

The light source of the backlight 4 will be described below. The light source of the backlight 4 is constituted of at least one blue light-emitting diode (blue LED) 2a, and at least one white light-emitting diode (white LED) 2b. Three types of light-emitting diodes can be used as the white LED 2b of the present embodiment: a type in which the surface of a blue LED is coated by a fluorescent material; a type in which the surface of a near-ultraviolet LED is coated by fluorescent materials; and a combination of a red LED, a green LED, and a blue LED.

A case in which the surface of a blue LED is coated by the fluorescent material will be described in detail. In this case, a property is relied upon in which the fluorescent material coated onto the surface of the blue LED exhibits fluorescence when blue light emitted by the blue LED is transmitted therethrough. As a result, the white LED 2b generates and emits white light by mixing blue light that is emitted from the blue LED and that passes through the fluorescent material as is, and light emitted due to the fluorescence of the fluorescent material.

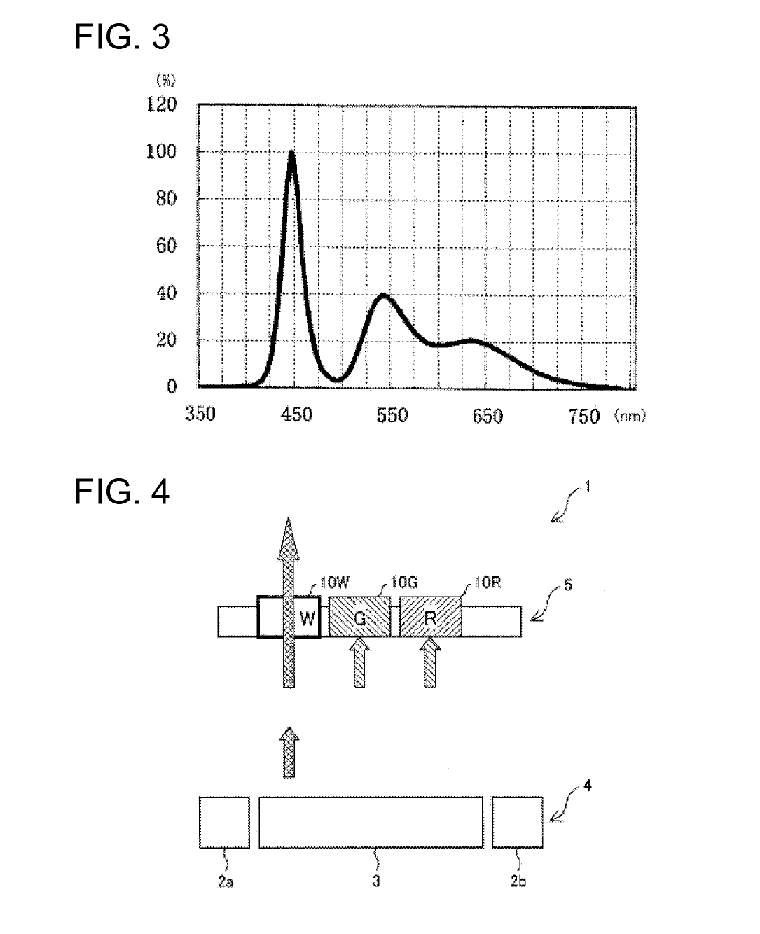

In a case in which the white LED 2b is constituted of a blue LED coated with a fluorescent material, a blue light-emitting diode such as a gallium arsenide (GaAs) or indium gallium nitride (InGaN) LED that is coated with a yellow fluorescent material or a combination of a red fluorescent material and a green fluorescent material can be used as the white LED 2b, for example. In this case, fluorescent materials that can be used for coating include YAG (yellow fluorescent material), GaALSiN3 red fluorescent material), and β-SiAlON (green fluorescent material). FIG. 2 shows the spectral distribution for a case in which the surface of a light-emitting diode that emits blue light is coated with a yellow fluorescent material. In this drawing, the horizontal axis is the wavelength (with “nm” as the unit), and the vertical axis is the relative intensity (with “%” as the unit). As shown in FIG. 2, the wavelength spectrum of the white LED 2b in a case in which an LED is coated with the yellow fluorescent material has a distribution with peaks in the blue part and the yellow part. Similarly, FIG. 3 shows a spectral distribution for a case in which the surface of a light-emitting diode that emits blue light is coated with a combination of a red fluorescent material and a green fluorescent material. In this drawing, the horizontal axis is the wavelength (with “nm” as the unit), and the vertical axis is the relative intensity (with “%” as the unit). As shown in FIG. 3, the wavelength spectrum of the white LED 2b in a case in which an LED is coated by a combination of a red fluorescent material and a green fluorescent material has a distribution with peaks in the blue part, the red part, and the green part. Similarly, the wavelength spectrum of the white LED 2b in a case in which the surface of a light-emitting diode that emits blue light is coated with the yellow fluorescent material has a distribution with peaks in the blue part and the yellow part.

The blue LED 2a is constituted of a light-emitting diode that emits blue light, and GaAs, InGaN, or the like can be used for the blue LED 2a, for example. In the backlight 4, the light emitted from the blue LED 2a and the light emitted from the white LED 2b are mixed in the light guide plate 3, and the backlight 4 emits the mixed light. The backlight 4 is also provided with an LED driver (not shown in the drawings) or the like for driving the light sources (2a and 2b). This LED driver is supplied with a control signal that controls the amount of light emitted and the like of the blue LED 2a and the white LED 2b from a control unit that is not shown in the drawings.

It is preferable that the ratio of the number of blue LEDs 2a to the number of white LEDs 2b be 1:1 if the intensity of the blue components is the same between the blue LED 2a and the white LED 2b. However, this ratio of the number of blue LEDs 2a to the number of white LEDs 2b is only one example, and there is no limit on the ratio of the number of LEDs as long as at least one blue LED 2a and one white LED 2b are disposed.

Also, it is preferable that the blue LED 2a and the white LED 2b be disposed along the faces between the light emitting surface and the light receiving surface of the light guide plate 3 (in other words, side faces of the light guide plate 3), thereby constituting an edge light type backlight 4. With this configuration, the usage efficiency of light from the light sources (2a and 2b) is high, and the backlight 4 can be made lighter weight. However, the backlight 4 is not limited to an edge light type and may be a direct lighting device in which the blue LED 2a and the white LED 2b are provided directly below the rear side of the liquid crystal panel 5.

(Driving the Backlight 4 and the Liquid Crystal Panel 5)

As stated above, the liquid crystal panel 5 of the present embodiment is provided with a red filter 10R, a green filter 10G, and a white filter 10W as color filters. Also, the backlight 4 of the present embodiment is provided with a blue LED 2a and a white LED 2b as light sources.

Based on the above configuration, the lighting method for each color in the liquid crystal display device 1 is as follows. First, the lighting method for blue will be described with reference to FIG. 4. FIG. 4 is a schematic drawing that shows the transmittance of light when blue light is emitted in the liquid crystal display device 1.

As shown in FIG. 4, when blue light is emitted, the control unit (not shown in the drawing) controls the LED driver, which is not shown in the drawing, such that only the blue LED 2a is lit. Also, at the same time, the drive unit that is not shown in the drawing controls the liquid crystal panel 5 such that light from the backlight 4 is only transmitted through the white filter 10W. As a result, the light emitted by the blue LED 2a is transmitted through the white filter 10W and is emitted from the liquid crystal panel 5. More specifically, the white filter 10W has a light transmittance of close to 100%, and thus transmits light from the blue LED 2a as is. As a result, blue light is emitted from the liquid crystal display device 1.

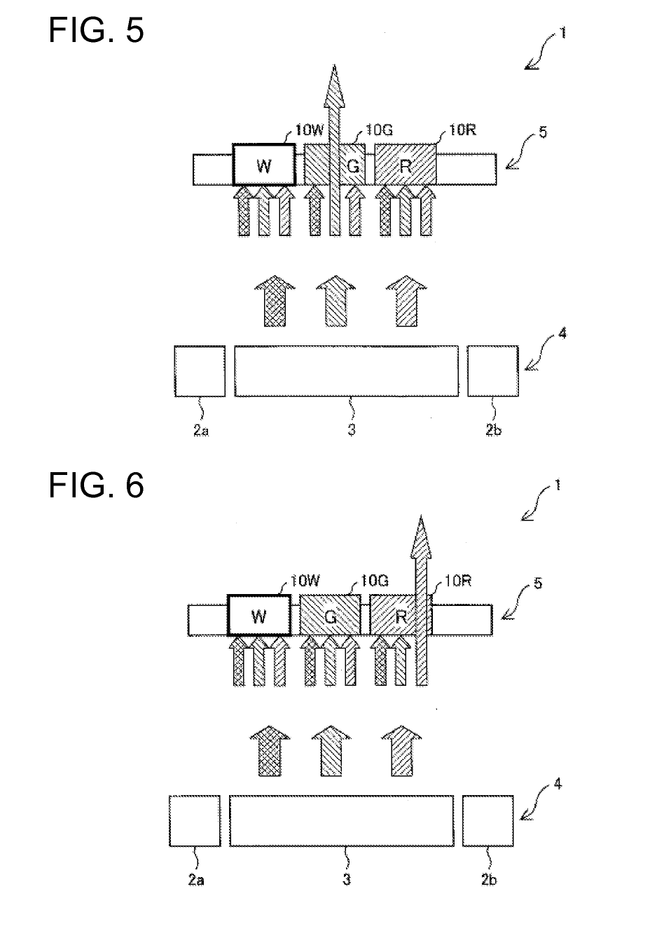

Next, the lighting method for green will be described with reference to FIG. 5. FIG. 5 is a schematic drawing that shows the transmittance of light when green light is emitted in the liquid crystal display device 1.

As shown in FIG. 5, when green light is emitted, the control unit (not shown in the drawing) controls the LED driver, which is not shown in the drawing, such that only the white LED 2b is lit. Also, at the same time, the drive unit that is not shown in the drawing controls the liquid crystal panel 5 such that light from the backlight 4 is only transmitted through the green filter 10G. As a result, light radiated from the white LED 2b passes through the green filter 10G and is emitted from the liquid crystal panel 5. More specifically, the green filter 10G allows only green components of the light emitted from the white LED 2b to be transmitted, but because the green filter 10G absorbs some of the light being transmitted, only some of the green component of the light is transmitted. As a result, green light is emitted from the liquid crystal display device 1.

Next, the lighting method for red will be described with reference to FIG. 6. FIG. 6 is a schematic drawing that shows the transmittance of light when red light is emitted in the liquid crystal display device 1.

As shown in FIG. 6, when red light is emitted, the control unit (not shown in the drawing) controls the LED driver, which is not shown in the drawing, such that only the white LED 2b is lit. Also, at the same time, the drive unit that is not shown in the drawing controls the liquid crystal panel 5 such that light from the backlight 4 is only transmitted through the red filter 10R. As a result, light radiated from the white LED 2b passes through the red filter 10R and is emitted from the liquid crystal panel 5. More specifically, the red filter 10R allows red components of the light emitted from the white LED 2b to be transmitted, but because the red filter 10R absorbs some of the light being transmitted, only some of the red component of the light is transmitted. As a result, red light is emitted from the liquid crystal display device 1.

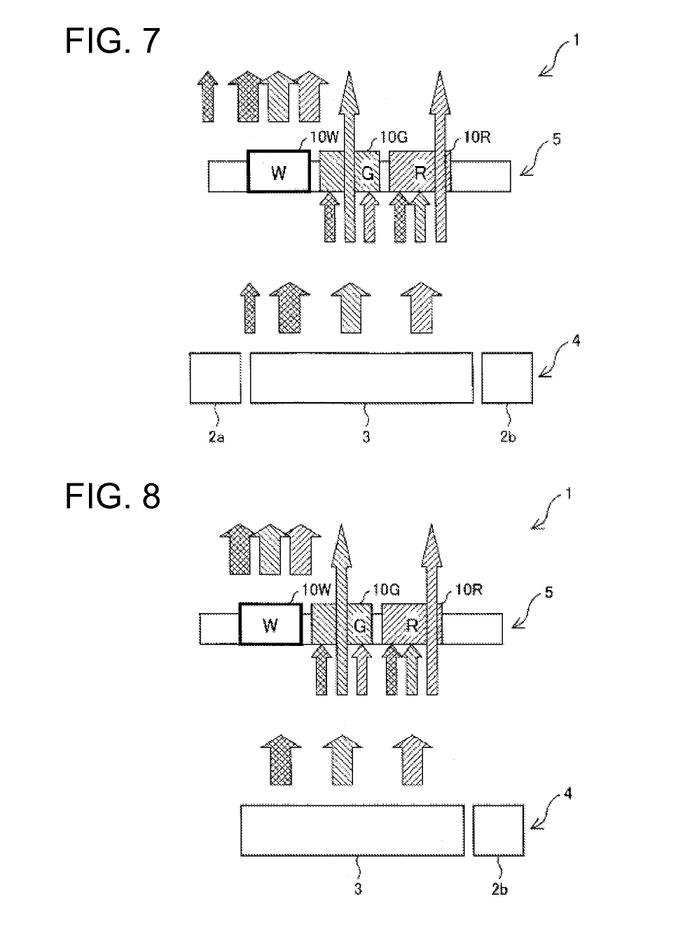

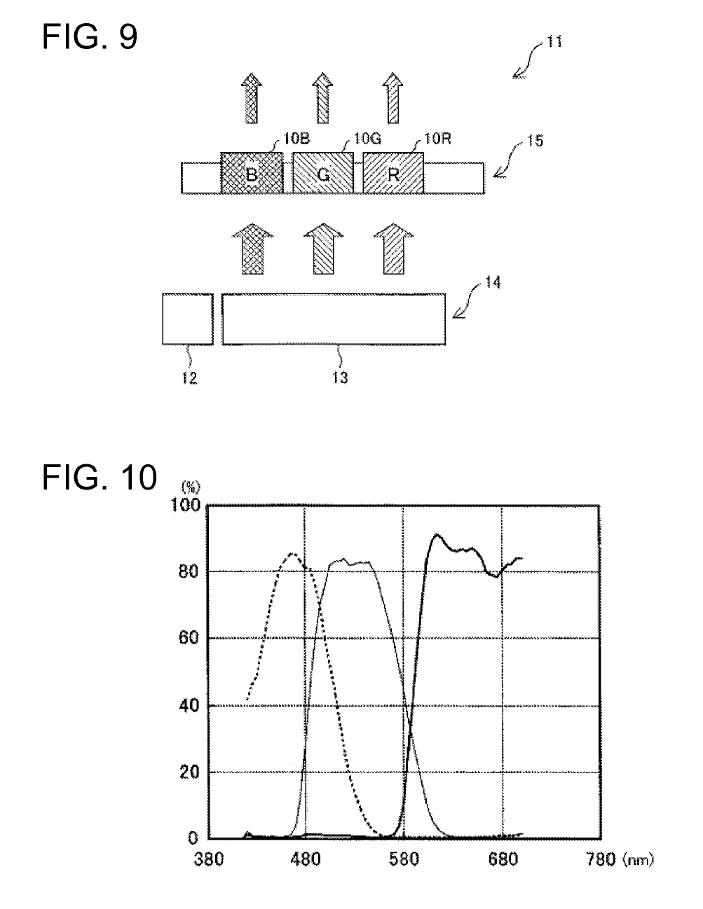

Finally, the lighting method for white will be described with reference to FIG. 7. FIG. 7 is a schematic drawing that shows the transmittance of light when white light is emitted in the liquid crystal display device 1.

As shown in FIG. 7, when white light is emitted, the control unit (not shown in the drawing) controls the LED driver, which is not shown in the drawing, such that the blue LED 2a and the white LED 2b are lit. Also, at the same time, the drive unit that is not shown in the drawing controls the liquid crystal panel 5 such that light from the backlight 4 is transmitted through the white filter 10W, the green filter 10G, and the red filter 10R. As a result, the light emitted from the blue LED 2a and the white LED 2b (specifically, the light mixed in the light guide plate 3) passes through the color filters of each color and is emitted from the liquid crystal panel 5. More specifically, the white filter 10W has a light transmittance of almost 100%, and thus, allows light emitted from the blue LED 2a and the white LED 2b to be transmitted as is. By contrast, the green filter 10G absorbs some of the transmitted light, and therefore, only allows some of the green component of the light emitted from the blue LED 2a and the white LED 2b to be transmitted. Similarly, the red filter 10R absorbs some of the transmitted light, and therefore, only allows some of the red component of the light emitted from the blue LED 2a and the white LED 2b to be transmitted. As a result, white light is emitted from the liquid crystal display device 1.

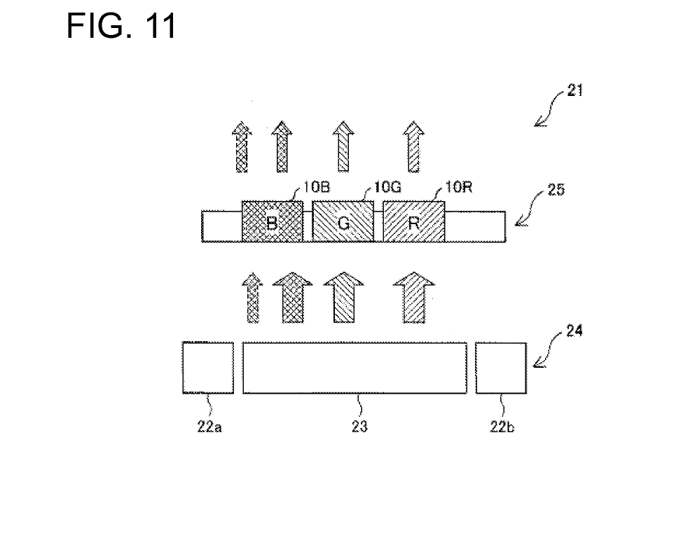

In a conventional liquid crystal display device, a red filter, a green filter, and a blue filter are generally used as color filters. Therefore, when emitting white light from a conventional liquid crystal display device, the light emitted from the blue LEDs and the white LEDs passes through the color filters of the respective colors and is emitted from the liquid crystal panel. More specifically, as shown in FIG. 11, the color filters of the respective colors selectively transmit the corresponding colors out of the light emitted from the blue LED and the white LED. In this case, the color filters absorb some of the transmitted light, and only transmit some of the red component of the light, some of the green component of the light, and some of the blue component of the light, out of the light emitted from the blue LED and the white LED. As a result, white is emitted from the liquid crystal display device, but because the light from the backlight is absorbed by the color filters, the amount of light emitted from the liquid crystal display device is small.

By contrast, in the liquid crystal display device 1 of the present embodiment, a white filter 10W is used instead of a blue filter, and thus, the light emitted from the blue LED 2a and the white LED 2b are transmitted as is through the white filter 10W. Thus, not much light is lost through absorption at the white filter 10W, which means that the amount of light emitted by the liquid crystal display device 1 is large. Thus, the liquid crystal display device 1 of the present embodiment has a high usage efficiency of light from the backlight 4 compared to a conventional liquid crystal display device, and the brightness of the liquid crystal display device 1 can be increased. Also, according to the present embodiment, it is possible to decrease the amount of light absorbed by the color filters, which reduces the amount of electrical power used by the liquid crystal display device 1.

In a conventional liquid crystal display device, in order to increase the color reproducibility (increase the NTSC rate), there are cases in which it is necessary to control the peak intensity of blue light in the mixed light from the blue LED and the white LED. For example, Japanese Patent Application Laid-Open Publication No. 2009-245902 discloses a configuration in which light that satisfies I₅₈₀/I₀>0.6 is emitted, where I₀ is the peak intensity of blue light among the mixed light from the blue LED and the white LED, and I₅₈₀ is the intensity when the wavelength is 580 nm.

However, in the present embodiment, such controls are not necessary. The reason is described with reference to FIG. 8. FIG. 8 is a schematic drawing that shows light being transmitted when only the white LED 2b is lit.

In the liquid crystal display device 1 of the present embodiment, if only the white LED 2b is lit, then as shown in FIG. 8, the light emitted from the white LED 2b is transmitted as is through the white filter 10W. On the other hand, the green filter 10G and the red filter 10R selectively transmit the corresponding colors out of the light emitted from the white LED 2b. As a result, the amount of blue component light is relatively small compared to when only the white LED is lit in a conventional liquid crystal display device. Thus, in the liquid crystal display device 1 of the present embodiment, it is not necessary to control the peak intensity of blue component light.

Also, in the liquid crystal display device 1 of the present embodiment, it is possible to display white by using the blue LED 2a and the white LED 2b. As a result, the brightness of the liquid crystal display device 1 can be increased.

As for a color reproduction method for the liquid crystal display device 1, time division display in which the lighting of the respective colors is conducted consecutively, or space division display in which the lighting of the respective colors is conducted simultaneously may be used, and there is no limit on the color reproduction method used.

Above, a configuration is shown in which the red filter 10R, the green filter 10G, and the white filter 10W are used as color filters and the blue LED 2a and the white LED 2b are used as the light sources, but the present invention is not limited to this. For example, a configuration can be used in which the green filter 10G and the white filter 10W are used as the color filters, and a red LED, a blue LED 2a, and a white LED 2b are used as the light sources. Even when using this configuration, the usage efficiency of light from the backlight 4 is high compared to a conventional liquid crystal display device, and the brightness of the liquid crystal display device 1 can be increased.

### SUMMARY OF EMBODIMENT

As stated above, in a liquid crystal display device according to one aspect of the present invention, the white light-emitting diode is another blue light-emitting diode that emits blue light in which the surface thereof is coated by a yellow fluorescent material or a combination of a red fluorescent material and a green fluorescent material, the white light-emitting diode is a near-ultraviolet light-emitting diode in which the surface thereof is coated by a red fluorescent material, a green fluorescent material, and a blue fluorescent material, or the white light-emitting diode is a combination of a red light-emitting diode that emits red light, a green light-emitting diode that emits green light, and another blue light-emitting diode that emits blue light.

According to the above configuration, it is possible to emit white light with high color rendering properties.

Also, in the liquid crystal display device according to one aspect of the present invention, a size ratio of the red filter, the green filter, and the white filter is 1:1:1.

According to this configuration, it is possible to provide the liquid crystal display device 1 with a high brightness and low electrical power usage.

The specific embodiments and examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The present invention can be applied to a liquid crystal display device used in various electronic devices such as television sets, personal computers, and mobile telephones.

### DESCRIPTION OF REFERENCE CHARACTERS

1, 11, 21 liquid crystal display device
2a, 22a blue LED
2b, 12, 22b white LED
3, 13, 23 light guide plate
4, 14, 24 backlight
5, 15, 25 liquid crystal panel
10R red filter
10G green filter
10B blue filter
10W white filter

1. A liquid crystal display device, comprising:
a light source that emits light towards an exterior; and
a liquid crystal panel to which the light from the light source is radiated,
wherein the light source is provided with at least one blue light-emitting diode that emits blue light, and at least one white light-emitting diode that emits white light, and
wherein, for each pixel, the liquid crystal panel is provided with at least one red filter that transmits light of a red wavelength region, at least one green filter that transmits light of a green wavelength region, and at least one white filter that transmits light of all wavelength regions.

2. The liquid crystal display device according to claim 1, wherein the white light-emitting diode is another blue light-emitting diode that emits blue light in which a surface thereof is coated by a yellow fluorescent material or a combination of a red fluorescent material and a green fluorescent material,
the white light-emitting diode is a near-ultraviolet light-emitting diode in which the surface thereof is coated by a red fluorescent material, a green fluorescent material, and a blue fluorescent material, or
the white light-emitting diode is a combination of a red light-emitting diode that emits red light, a green light-emitting diode that emits green light, and another blue light-emitting diode that emits blue light.

3. The liquid crystal display device according to claim 1, wherein a size ratio of the red filter, the green filter, and the white filter is 1:1:1.

4. A color reproduction method of the liquid crystal display device according to claim 1, comprising:
when producing red, lighting the white light-emitting diode and emitting light from the white light-emitting diode through the red filter;
when producing green, lighting the white light-emitting diode and emitting light from the white light-emitting diode through the green filter;
when producing blue, lighting the blue light-emitting diode and emitting light from the blue light-emitting diode through the white filter; and
when producing white, lighting the blue light-emitting diode and the white light-emitting diode and emitting light from the blue light-emitting diode and light from the white light-emitting diode through the red filter, the green filter, and the white filter.
